(19) United States
(12) Patent Application Publication
(10) Pub. No.: US 2025/0076789 A1
(43) Pub. Date: Mar. 6, 2025

(54) IMAGE FORMING APPARATUS

(71) Applicant: Kaoru TADA, Kanagawa (JP)

(72) Inventor: Kaoru TADA, Kanagawa (JP)

(73) Assignee: Ricoh Company, Ltd., Tokyo (JP)

(21) Appl. No.: 18/785,707

(22) Filed: Jul. 26, 2024

(30) Foreign Application Priority Data
Aug. 29, 2023 (JP) 2023-138709

(51) Int. Cl. G03G 15/16; G03G 15/00; G03G 21/06

(52) U.S. Cl. CPC G03G 15/1605; G03G 15/657; G03G 15/80; G03G 21/06

(57) ABSTRACT

An image forming apparatus includes a body, a transfer member, a transfer unit, a power supply, and an urging member. The transfer member transfers an image onto a transfer medium. The transfer unit is supported to rotate around a support shaft with respect to the body and holds the transfer member. The power supply outputs a transfer bias to be applied to the transfer member. The urging member urges the transfer unit in a direction in which the transfer unit contacts a positioning portion of the body and is a part or all of a power supply path of the transfer bias from the power supply to the transfer member.

### CROSS-REFERENCE TO RELATED APPLICATION

This patent application is based on and claims priority pursuant to 35 U.S.C. § 119 (a) to Japanese Patent Application No. 2023-138709, filed on Aug. 29, 2023, in the Japan Patent Office, the entire disclosure of which is hereby incorporated by reference herein.

### BACKGROUND

### Technical Field

Embodiments of the present disclosure relate to an image forming apparatus such as a copying machine, a printer, a facsimile machine, or a multifunction peripheral thereof, or a printing machine, in which a transferor such as a secondary transfer roller is disposed.

### Related Art

In an image forming apparatus such as a copier or a printer, a technology is known that a transfer unit for holding a secondary transfer roller (transferor) is urged by an urging member to contact the transfer unit to a positioning portion of a body of an image forming apparatus, such that the transfer unit is positioned with respect to the body of the image forming apparatus.

On the other hand, another technology is known that a power supply terminal disposed on a body cover is contacted to a power-supplied member such as a secondary transfer roller in conjunction with an operation of closing the body cover, such that power supply from a power supply to the power-supplied member is enabled.

### SUMMARY

In an embodiment of the present disclosure, an image forming apparatus includes a body, a transfer member, a transfer unit, a power supply, and an urging member. The transfer member transfers an image onto a transfer medium. The transfer unit is supported to rotate around a support shaft with respect to the body and holds the transfer member. The power supply outputs a transfer bias to be applied to the transfer member. The urging member urges the transfer unit in a direction in which the transfer unit contacts a positioning portion of the body and is a part or all of a power supply path of the transfer bias from the power supply to the transfer member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIGS. 2A and 2B are diagrams illustrating an operation of opening an opening-and-closing cover of the image forming apparatus of FIG. 1;

FIG. 3 is a schematic view of a secondary transfer unit and a vicinity of the secondary transfer unit; and

FIG. 4 is a schematic view of a secondary transfer unit and a vicinity of the secondary transfer unit, according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

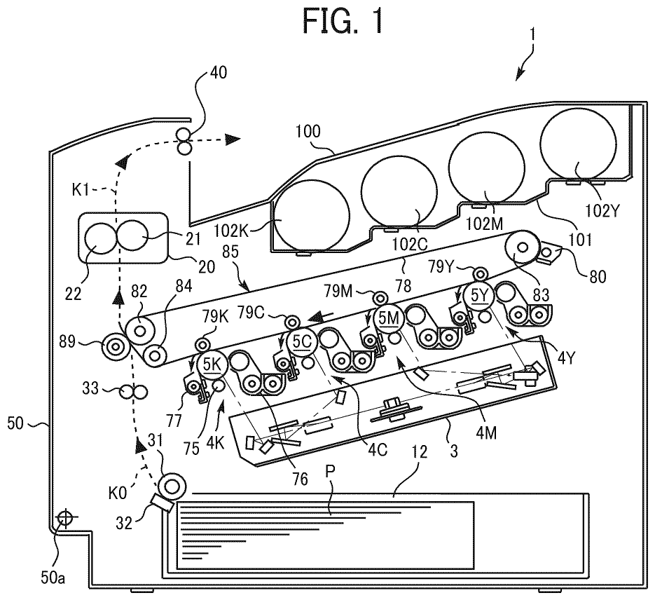

First, with reference to FIG. 1, a description is given of an overall configuration and operation of an image forming apparatus 1 according to an embodiment of the present disclosure. As illustrated in FIG. 1, the image forming apparatus 1 according to the present embodiment is a tandem-type color printer. Four toner bottles 102Y, 102M, 102C, and 102K corresponding to respective colors (yellow, magenta, cyan, and black) are detachably (replaceably) attached to a bottle housing 101 located above a body of the image forming apparatus 1. An intermediate transfer unit 85 is disposed below the bottle housing 101. Image forming devices 4Y, 4M, 4C, and 4K corresponding to the respective colors (yellow, magenta, cyan, and black) are arranged in parallel to face an intermediate transfer belt 78 (an intermediate transferor) of the intermediate transfer unit 85. The image forming apparatus 1 includes a sheet feeder 12 (a sheet tray) in a lower portion of the body of the image forming apparatus 1. The sheet feeder 12 stores a stack of multiple sheets P such as sheets of paper stacked on one on another. On the left of the image forming apparatus 1, an opening-and-closing cover 50 for exposing the inside of the image forming apparatus 1 (for example, conveyance paths K0 and K1 of the sheet P, and a fixing device 20) is disposed to be openable and closable.

The image forming devices 4Y, 4M, 4C, and 4K include photoconductor drums 5Y, 5M, 5C, and 5K, respectively. Each of the photoconductor drums 5Y, 5M, 5C, and 5K is surrounded by, for example, a charger 75, a developing device 76, a cleaner 77, and a charge eliminating device. Image forming processes including a charging process, an exposure process, a developing process, a primary transfer process, and a cleaning process are performed on each of the photoconductor drums 5Y, 5M, 5C, and 5K to form yellow, magenta, cyan, and black toner images on the photoconductor drums 5Y, 5M, 5C, and 5K, respectively.

A main motor drives to rotate the photoconductor drums 5Y, 5M, 5C, and 5K counterclockwise in FIG. 1. The charger 75 disposed opposite each of the photoconductor drums 5Y, 5M, 5C, and 5K uniformly charges the outer circumferential surface thereof (a charging process). After the charging process, the charged outer circumferential surface of each of the photoconductor drums 5Y, 5M, 5C, and 5K reaches an irradiation position at which an exposure device 3 (in other words, a writing device) irradiates and scans the photoconductor drums 5Y, 5M, 5C, and 5K with laser beams. At the irradiation position, the photoconductor drums 5Y, 5M, 5C, and 5K are irradiated and scanned with the laser beams L forms electrostatic latent images according to yellow, magenta, cyan, and black image data (an exposure process).

After the exposure process, the irradiated and scanned outer circumferential surface of each of the photoconductor drums 5Y, 5M, 5C, and 5K reaches a developing position at which the developing device 76 is disposed opposite each of the photoconductor drums 5Y, 5M, 5C, and 5K, and the developing device 76 develops the electrostatic latent image formed on the respective photoconductor drums 5Y, 5M, 5C, and 5K, thus forming yellow, magenta, cyan, and black toner images on the photoconductor drums 5Y, 5M, 5C, and 5K (a developing process). After the developing process, the yellow, magenta, cyan, and black toner images formed on the photoconductor drums 5Y, 5M, 5C, and 5K reach primary transfer nips formed between the photoconductor drums 5Y, 5M, 5C, and 5K and the intermediate transfer belt 78 by four primary transfer bias rollers 79Y, 79M, 79C, and 79K pressed against the four photoconductor drums 5Y, 5M, 5C, and 5K via the intermediate transfer belt 78, respectively, and the yellow, magenta, cyan, and black toner images are primarily transferred onto the intermediate transfer belt 78 (a primary transfer process). After the primary transfer process, residual toner (untransferred toner) onto the intermediate transfer belt 78 slightly remains on the photoconductor drums 5Y, 5M, 5C, and 5K.

After the primary transfer process, the residual toner (untransferred toner) on each of the photoconductor drums 5Y, 5M, 5C, and 5K reaches a cleaning position at which the cleaner 77 is disposed opposite each of the photoconductor drums 5Y, 5M, 5C, and 5K, and a cleaning blade of the cleaner 77 mechanically collects the residual toner from each of the photoconductor drums 5Y, 5M, 5C, and 5K (a cleaning process). Finally, the cleaned outer circumferential surface of each of the photoconductor drums 5Y, 5M, 5C, and 5K reaches a charge removal position at which the charge removing device is disposed opposite a corresponding one of the photoconductor drums 5Y, 5M, 5C, and 5K, and the charge removing device eliminates residual potential from each of the photoconductor drums 5Y, 5M, 5C, and 5K. Thus, a series of image forming processes performed on the photoconductor drums 5Y, 5M, 5C, and 5K is finished.

The yellow, magenta, cyan, and black toner images formed on the photoconductor drums 5Y, 5M, 5C, and 5K in the developing process are primarily transferred onto an outer circumferential surface of the intermediate transfer belt 78 (intermediate transferor) such that the yellow, magenta, cyan, and black toner images are superimposed on the intermediate transfer belt 78. Thus, a color toner image is formed on the surface of the intermediate transfer belt 78. The intermediate transfer unit 85 includes the intermediate transfer belt 78 as an intermediate transferor, the four primary transfer bias rollers 79Y, 79M, 79C, and 79K, a secondary-transfer backup roller 82, a cleaning backup roller 83, a tension roller 84, and an intermediate transfer cleaner 80. The intermediate transfer belt 78 is extended and supported by the three rollers, that is, the secondary-transfer backup roller 82, the cleaning backup roller 83, and a tension roller 84. One of the three rollers, that is, the secondary-transfer backup roller 82 is coupled to the main motor to drive and rotate the intermediate transfer belt 78 in a rotation direction indicated by an arrow in FIG. 1.

The four primary transfer bias rollers 79Y, 79M, 79C, and 79K are pressed against the corresponding photoconductor drums 5Y, 5M, 5C, and 5K, respectively, via the intermediate transfer belt 78 to form primary transfer nips. Each of the primary transfer bias rollers 79Y, 79M, 79C, and 79K is applied with a primary transfer bias having a polarity opposite a polarity of electric charge of toner. The intermediate transfer belt 78 moves in the direction indicated by the arrow in FIG. 1 and sequentially passes through the primary transfer nips of the primary transfer bias rollers 79Y, 79M, 79C, and 79K. Thus, the toner images formed on the respective photoconductor drums 5Y, 5M, 5C, and 5K are primarily transferred onto the intermediate transfer belt 78 while being superimposed one atop another to form a composite color toner image on the intermediate transfer belt 78 (a primary transfer process).

Subsequently, the intermediate transfer belt 78 to which the superimposed toner images of yellow, magenta, cyan, and black have been transferred reaches a position opposite (facing) a secondary transfer roller 89 as a transferor. At this position, the secondary-transfer backup roller 82 and the secondary transfer roller 89 (transferor) nip the intermediate transfer belt 78 therebetween to form a secondary transfer nip. The toner images of four colors formed on the intermediate transfer belt 78 are transferred (secondarily transferred) onto the sheet P conveyed to the position of the secondary transfer nip (a secondary transfer process). At this time, untransferred toner that is not transferred onto the sheet P remains on the surface of the intermediate transfer belt 78. The surface of the intermediate transfer belt 78 then reaches a position opposite the intermediate transfer cleaner 80. At this position, the intermediate transfer cleaner 80 collects the untransferred toner from the intermediate transfer belt 78. Thus, a series of transfer processes performed on the intermediate transfer belt 78 is completed.

The sheet P is conveyed from the sheet feeder 12 disposed in the lower portion of the body of the image forming apparatus 1 to the secondary transfer nip via the conveyance path K0. Specifically, the sheet feeder 12 contains a stack of multiple sheets P (transfer media) such as sheets of paper stacked on one on another. As a sheet feed roller 31 is rotated counterclockwise in FIG. 1, the uppermost sheet P nipped between the sheet feed roller 31 and a friction pad 32 is fed toward between the rollers of a registration roller pair 33 (timing roller pair) while the sheet P is guided by guide plates forming the conveyance path K0.

The sheet P conveyed to the registration roller pair 33 serving as a timing roller pair temporarily stops at a position of a roller nip (nip portion) of the registration roller pair 33 that stops rotating. Rotation of the registration roller pair 33 is timed to convey the sheet P toward the secondary transfer nip such that the sheet P as a transfer medium meets the color toner image on the intermediate transfer belt 78 at the secondary transfer nip. Thus, the desired color toner image is transferred onto the sheet P.

Subsequently, the sheet P, onto which the color toner image is transferred at the secondary transfer nip, is conveyed to a position of a fixing device 20 via a conveyance path. At this point, that is, at a fixing nip formed by a fixing belt 21 and a pressure roller 22 pressing each other, the toner image transferred onto the surface of the sheet P is fixed onto the sheet P by heat and pressure from a fixing belt (a fixing process).

After the fixing process, the sheet P bearing the fixed toner image is conveyed through the conveyance path K1 and ejected by a sheet ejection roller pair 40 to the outside of the image forming apparatus 1. The sheets P ejected one by one by the sheet ejection roller pair 40 to the outside of the image forming apparatus 1 are sequentially stacked as output images on a stacker 100. Thus, a series of image forming processes performed by the image forming apparatus 1 is completed.

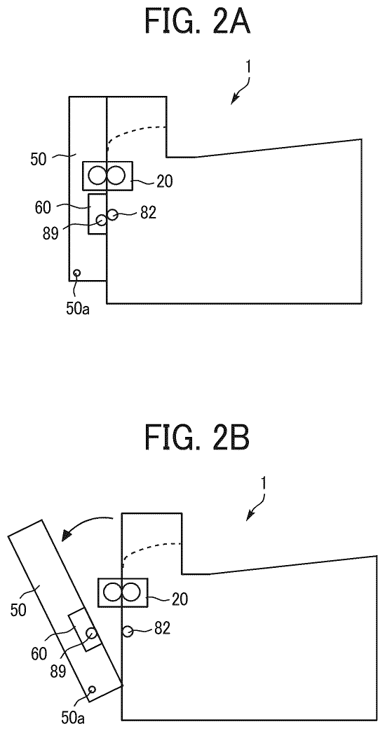

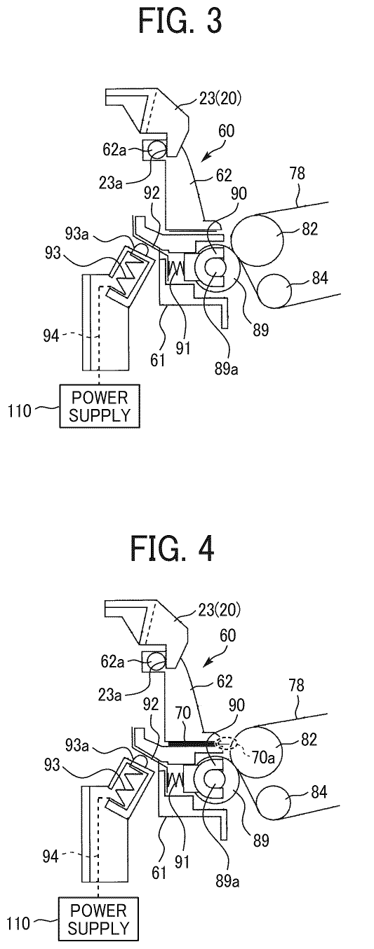

With reference to FIGS. 2A, 2B, and 3, a description is given of a configuration and operation of the image forming apparatus 1 according to the present embodiment in detail below. As described above with reference to FIG. 1, the opening-and-closing cover 50 for opening and closing the inside of the image forming apparatus 1 is disposed on the left of the image forming apparatus 1 according to the present embodiment. With reference to FIGS. 2A and 2B, the opening-and-closing cover 50 is rotatable around a support shaft 50a in order to open and close the inside of the image forming apparatus 1. The opening-and-closing cover 50 holds a secondary transfer unit 60 (which holds a secondary transfer roller 89) to be described later. Accordingly, the secondary transfer unit 60 is rotated around the support shaft 50a together with the opening-and-closing cover 50 in conjunction with the opening and closing operation of the opening-and-closing cover 50.

Specifically, when the opening-and-closing cover 50 in a closed state as illustrated in FIG. 2A (and FIG. 1) is rotated clockwise (in the direction indicated by the arrow in FIG. 2B) around the support shaft 50a together with the secondary transfer unit 60 as illustrated in FIG. 2B, a part of the inside of the image forming apparatus 1 (for example, the first conveyance path K0, the second conveyance path K1, the secondary transfer unit 60, and the fixing device 20) is opened (exposed), so that the sheet P jammed in the first conveyance path K0, the second conveyance path K1, and the fixing device 20 can be removed, and attachment and detachment of the secondary transfer unit 60 and the fixing device 20 for maintenance can be performed. When the opening-and-closing cover 50 in an open state as illustrated in FIG. 2B is rotated clockwise in FIG. 2B around the support shaft 50a together with the secondary transfer unit 60, the opening-and-closing cover 50 turns to a closed state as illustrated FIGS. 2A and 3, and then the secondary transfer roller 89 contacts the intermediate transfer belt 78 to form the secondary transfer nip.

As described above with reference to FIG. 1, the image forming apparatus 1 according to the present embodiment includes the secondary transfer roller 89 as a transfer member for transferring an image onto the sheet P as a transfer medium. The secondary transfer roller 89 as a transfer member is a roller that contacts the intermediate transfer belt 78 as an intermediate transferor to form a secondary transfer nip, and secondarily transfers an image primarily transferred onto the intermediate transfer belt 78 onto the sheet P as a transfer medium conveyed to the secondary transfer nip. The secondary transfer roller 89 includes a shaft 89a (see FIG. 3) made of a conductive material such as stainless steel. An elastic layer is formed (coated) on the shaft 89a. The elastic layer of the secondary transfer roller 89 is a solid rubber or a foam-sponge rubber made of, e.g., polyurethane, ethylene-propylene-diene monomer (EPDM), or silicone having a conductive filler such as carbon dispersed or containing an ionic conductive material.

With reference to FIG. 3, the image forming apparatus 1 according to the present embodiment includes a power supply 110 for outputting a transfer bias (a secondary transfer bias) to be applied to the secondary transfer roller 89 (transfer member). The power supply 110 applies the secondary transfer bias having a polarity different from the polarity of the toner to the secondary transfer roller 89 to form a secondary-transfer electric field at the position of the secondary transfer nip, the toner borne on the outer circumferential surface (toner bearing surface) of the intermediate transfer belt 78 is electrostatically moved toward the secondary transfer roller 89. The secondary transfer bias may be a direct-current voltage, or a direct-current voltage on which an alternating-current voltage is superimposed.

With reference to FIG. 3 (and FIGS. 2A and 2B), the image forming apparatus 1 according to the present embodiment includes the secondary transfer unit 60 as a transfer unit that holds the secondary transfer roller 89 (transfer member). The secondary transfer unit 60 (transfer unit) is supported to be rotatable around the support shaft 50a with respect to the body of the image forming apparatus 1. Specifically, as described above with reference to FIGS. 2A and 2B, the secondary transfer unit 60 is held by the opening-and-closing cover 50 that is rotatable (openable and closable) around the support shaft 50a. The secondary transfer unit 60 includes a conveyance guide 62 that guides the sheet P sent out from the secondary transfer nip, in addition to a holding portion 61 that rotatably holds the secondary transfer roller 89.

The conveyance guide 62 of the secondary transfer unit 60 is a member that is disposed downstream from the secondary transfer nip in a sheet conveyance direction and upstream from a fixing entrance guide 23 of the fixing device 20 in the sheet conveyance direction, and guides the sheet P sent out from the secondary transfer nip toward the fixing device 20 (fixing entrance guide 23) after the secondary transfer process.

The holding portion 61 of the secondary transfer unit 60 holds a bearing that rotatably holds the shaft 89a of the secondary transfer roller 89 such that a part of the secondary transfer roller 89 fits into a concave portion (a portion recessed in a direction away from the secondary transfer nip). The secondary transfer unit 60 (holding portion 61) includes a fitting member 90 that fits to the shaft 89a of the secondary transfer roller 89 and a second compression spring 91 as a second urging member that urges the fitting member 90 such that the secondary transfer roller 89 contacts the intermediate transfer belt 78 (intermediate transferor). The fitting member 90 fits into a groove (in which the second compression spring 91 is disposed) formed in the holding portion 61 and is slidable in the left-and-right direction (a direction in which the groove extends, and a direction in which the fitting member 90 contacts and separates from the intermediate transfer belt 78) in FIG. 3.

With reference to FIG. 3, the image forming apparatus 1 according to the present embodiment includes a first compression spring 93 serving as an urging member that urges the secondary transfer unit 60 (transfer unit) such that the secondary transfer unit 60 contacts a positioning portion 23a of the body of the image forming apparatus 1. Specifically, the positioning portion 23a is a portion that protrudes downward at an end of the fixing entrance guide 23 of the fixing device 20 in the width direction (the direction perpendicular to the plane on which FIG. 3 is illustrated). On the other hand, the conveyance guide 62 of the secondary transfer unit 60 has a contact portion 62a (the portion protruding in a boss shape in the width direction) that contacts the positioning portion 23a at an end of the conveyance guide 62 in the width direction. The secondary transfer unit 60 is urged obliquely to the upper right in FIG. 3 by the first compression springs 93 disposed at the end of the conveyance guide 62 in the width direction, such that the contact portion 62a of the secondary transfer unit 60 contacts the positioning portion 23a, and thus the position of the secondary transfer unit 60 in the image forming apparatus 1 is accurately determined. Accordingly, the position of the secondary transfer nip is accurately determined, so that the secondary transfer process is preferably performed. The position of the conveyance guide 62 in the image forming apparatus 1 is also accurately determined, so that the performance of conveying the sheet P from the secondary transfer nip to the fixing nip is also enhanced. The components (for example, the first compression spring 93, the contact portion 62a, and the positioning portion 23a) related to the positioning of the secondary transfer unit 60 are disposed at both ends of the secondary transfer unit 60 in the width direction. In order to efficiently perform the positioning as described above, it is preferable that the urging direction of the first compression spring 93 and the direction in which the contact portion 62a contacts the positioning portion 23a coincide with each other.

In the present embodiment, the secondary transfer unit 60 is held to be movable in a direction in which the secondary transfer unit 60 contacts the intermediate transfer belt 78 in the opening-and-closing cover 50 and a direction in which the secondary transfer unit 60 separates from the intermediate transfer belt 78 in the opening-and-closing cover 50. The first compression spring 93 is disposed on a body of the opening-and-closing cover 50 (indirectly disposed on the body of the image forming apparatus 1) and is disposed to urge the secondary transfer unit 60 in the above-described direction in the opening-and-closing cover 50. On the other hand, the secondary transfer unit 60 may be fixed to the opening-and-closing cover 50, and the first compression spring 93 may be directly disposed in the body of the image forming apparatus 1 without using the opening-and-closing cover 50. In this case, the entire positioning of the opening-and-closing cover 50 is determined by the contact between the positioning portion 23a and the contact portion 62a of the secondary transfer unit 60. In the present embodiment, the positioning portion 23a with which the contact portion 62a of the secondary transfer unit 60 contacts is disposed in the fixing entrance guide 23 of the fixing device 20. However, the position (member) where the positioning portion is disposed is not limited thereto.

The first compression spring 93 serving as an urging member in the present embodiment functions as a part of a power supply path of the secondary transfer bias from the power supply 110 to the secondary transfer roller 89 (transfer member). Specifically, the first compression spring 93 is made of a conductive material such as metal, and one end of the first compression spring 93 is connected to the power supply 110 via a first power supply path 94 (for example, formed of a harness). The second compression spring 91 and the fitting member 90 of the secondary transfer unit 60 (holding portion 61) described above are made of a conductive material such as metal or conductive resin. The secondary transfer unit 60 (holding portion 61) includes a conductive plate 92. One end of the conductive plate 92 is connected to the second compression spring 91 (second urging member), and the other end of the conductive plate 92 is connected to a contact portion 93a, which is conductive and has a certain degree of rigidity, formed on the other end of the first compression spring 93. With such a configuration, the secondary transfer bias (transfer bias) output from the power supply 110 (first power supply path 94) is applied to the shaft 89a of the secondary transfer roller 89 via the first compression spring 93, the conductive plate 92, the second compression spring 91 (second urging member), and the fitting member 90. Components that function only as power supply paths (mainly the conductive plate 92 or the first power supply path 94) without being related to the positioning of the secondary transfer unit 60 are not disposed at both ends in the width direction, but are disposed only at one end in the width direction.

As described above, in the present embodiment, the first compression spring 93 (urging member) having a function of positioning the secondary transfer unit 60 with respect to the body of the image forming apparatus 1 also functions as a power supply path for applying the secondary transfer bias from the power supply 110 to the secondary transfer roller 89. Such a configuration allows the simplified structure and cost reduction of the image forming apparatus 1 compared to a case where a member having a positioning function and a member having a power supply function are separately disposed. In the present embodiment, the first compression spring 93 (urging member) functions as a part of the power supply path of the secondary transfer bias from the power supply 110 to the secondary transfer roller 89. However, the first compression spring 93 may be directly connected to the secondary transfer roller 89 to function as the entire power supply path.

### Modification

As illustrated in FIG. 4, the secondary transfer unit 60 (transfer unit) according to the modification includes a charge eliminating member 70 that eliminates charge of the sheet P sent out from the secondary transfer nip between the conveyance guide 62 and the holding portion 61 that rotatably holds the secondary transfer roller 89. The charge eliminating member 70 includes a needle-shaped charge eliminating plate 70a at the tip thereof, and eliminates the charge accumulated on the sheet P after the secondary transfer process to reduce the inconvenience of the sheet P being electrostatically attracted to the conveyance guide 62. In the modification, the first compression spring 93 having the function of positioning the secondary transfer unit 60 also has a function of determining the position of the charge eliminating member 70 in the image forming apparatus 1. Accordingly, the above-described charge eliminating function of the charge eliminating member 70 is preferably exhibited.

As described above, the image forming apparatus 1 according to the present embodiment includes the secondary transfer roller 89 (transfer member) for transferring an image onto the sheet P (transfer medium), and the secondary transfer unit 60 (transfer unit) that is supported to be rotatable around the support shaft 50a with respect to the body of the image forming apparatus 1 and holds the secondary transfer roller 89. The image forming apparatus 1 further includes the power supply 110 that outputs the secondary transfer bias (transfer bias) to be applied to the secondary transfer roller 89, and the first compression spring 93 (urging member) that urges the secondary transfer unit 60 such that the secondary transfer unit 60 contacts the positioning portion 23a of the body of the image forming apparatus 1. The first compression spring 93 functions as a part or all of a power supply path of the secondary transfer bias from the power supply 110 to the secondary transfer roller 89. Such a configuration easily performs the positioning of the secondary transfer unit 60 in which the secondary transfer roller 89 (transfer member) is held with respect to the body of the image forming apparatus 1, and the supply of power to the secondary transfer roller 89.

In the present embodiment, the present disclosure is applied to the color image forming apparatus 1. However, the present disclosure is applied to a monochrome image forming apparatus as well. In this case, the transfer member to which the present disclosure is applied is, for example, a transfer roller that contacts a photoconductor such as a photoconductor drum to form a transfer nip through which a sheet P as a transfer medium is conveyed. In the present embodiment, the secondary transfer roller 89 is used as a transfer member to which the present disclosure is applied. However, each of the primary transfer bias rollers 79Y, 79M, 79C, and 79K may also be used as a transfer member to which the present disclosure is applied. In this case, the transfer medium to which an image is transferred by the transfer member is the intermediate transfer belt 78. In the present embodiment, the secondary transfer roller 89 that contacts the intermediate transfer belt 78 to form a transfer nip is used as a transfer member to which the present disclosure is applied. However, a secondary transfer charger that faces the intermediate transfer belt 78 without contact may be used as the transfer member to which the present disclosure is applied. In the present embodiment, the first compression spring 93 is used as an urging member having the positioning function and the power supplying function. However, the urging member is not limited thereto, and for example, a plate spring may be used. Even in such a case, advantageous effects equivalent to the effects of the above-described embodiments can be obtained.

The above-described embodiments and modifications are illustrative and do not limit this disclosure. Thus, numerous additional modifications and variations are possible in light of the above teachings. For example, elements and/or features of different illustrative and exemplary embodiments herein may be combined with each other and/or substituted for each other within the scope of this disclosure and appended claims. Further, features of components of the embodiments, such as the number, the position, and the shape are not limited the embodiments and thus may be preferably set.

Aspects of the present disclosure may be, for example, combinations of first to fifth aspects as follows.

### First Aspect

An image forming apparatus (e.g., the image forming apparatus 1) includes a transfer member (e.g., the secondary transfer roller 89) to transfer an image onto a transfer medium, a transfer unit (e.g., the secondary transfer unit 60) that is supported to be rotatable around a support shaft (e.g., the support shaft 50a) with respect to a body of the image forming apparatus and holds the transfer member, a power supply (e.g., the power supply 110) to output a transfer bias to be applied to the transfer member, and an urging member (e.g., the first compression spring 93) to urge the transfer unit such that the transfer unit contacts a positioning portion (e.g., the positioning portion 23a) of the body of the image forming apparatus. The urging member functions as a part or all of a power supply path (e.g., the conductive plate 92, the first power supply path 94) of the transfer bias from the power supply to the transfer member.

### Second Aspect

In the image forming apparatus (e.g., the image forming apparatus 1) according to the first aspect, the transfer member (e.g., the secondary transfer roller 89) is a secondary transfer roller that contacts an intermediate transfer member (e.g., the intermediate transfer belt 78) to form a secondary transfer nip and secondarily transfers the image, which has been primarily transferred onto the intermediate transfer member, to a sheet (e.g., the sheet P) as the transfer medium conveyed to the secondary transfer nip. The urging member (e.g., the first compression spring 93) is a compression spring made of a conductive material.

### Third Aspect

In the image forming apparatus (e.g., the image forming apparatus 1) according to the second aspect, the transfer unit (e.g., the secondary transfer unit 60) includes a fitting member (e.g., the fitting member 90) that fits to a shaft (e.g., the shaft 89a) of the secondary transfer roller, a second urging member (e.g., the second compression spring 91) that urges the fitting member such that the secondary transfer roller contacts the intermediate transfer member (e.g., the intermediate transfer belt 78), and a conductive plate (e.g., the conductive plate 92) having one end connected to the second urging member and the other end connected to the compression spring. The transfer bias output from the power supply (e.g., the power supply 110) is applied to the secondary transfer roller via the compression spring, the conductive plate, the second urging member, and the fitting member.

### Fourth Aspect

In the image forming apparatus (e.g., the image forming apparatus 1) according to the second or third aspect, the transfer unit (e.g., the secondary transfer unit 60) includes a conveyance guide (e.g., the conveyance guide 62) to guide the sheet (e.g., the sheet P) sent out from the secondary transfer nip. The conveyance guide includes a contact portion (e.g., the contact portion 62a) that contacts the positioning portion (e.g., the positioning portion 23a).

### Fifth Aspect

In the image forming apparatus (e.g., the image forming apparatus 1) according to the fourth aspect, the transfer unit (e.g., the secondary transfer unit 60) includes a charge eliminating member (e.g., the charge eliminating member 70) to eliminate charge of the sheet (e.g., the sheet P) sent out from the secondary transfer nip. The charge eliminating member is disposed between the conveyance guide (e.g., the conveyance guide 62) and a holding portion (e.g., the holding portion 61) that rotatably holds the secondary transfer roller.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image forming apparatus comprising:
a body;
a transfer member to transfer an image onto a transfer medium;
a transfer unit supported to rotate around a support shaft with respect to the body, the transfer unit holding the transfer member;
a power supply to output a transfer bias to be applied to the transfer member; and
an urging member urging the transfer unit in a direction in which the transfer unit contacts a positioning portion of the body, the urging member being a part or all of a power supply path of the transfer bias from the power supply to the transfer member.

2. The image forming apparatus according to claim 1,
wherein the transfer member is a secondary transfer roller that contacts an intermediate transfer member to form a secondary transfer nip and secondarily transfer the image, which has been primarily transferred onto the intermediate transfer member, to a sheet as the transfer medium conveyed to the secondary transfer nip, and
wherein the urging member is a compression spring made of a conductive material.

3. The image forming apparatus according to claim 2,
wherein the transfer unit includes:
a fitting member to fit to a shaft of the secondary transfer roller;
another urging member urging the fitting member in a direction in which the secondary transfer roller contacts the intermediate transfer member; and
a conductive plate having one end connected to said another urging member and another end connected to the compression spring, and
wherein the transfer bias output from the power supply is applied to the secondary transfer roller via the compression spring, the conductive plate, said another urging member, and the fitting member.

4. The image forming apparatus according to claim 2,
wherein the transfer unit includes a conveyance guide to guide the sheet sent out from the secondary transfer nip, and
wherein the conveyance guide includes a contact portion that contacts the positioning portion.

5. The image forming apparatus according to claim 4,
wherein the transfer unit includes:
a holding portion rotatably holding the secondary transfer roller; and
a charge eliminating member to eliminate charge of the sheet sent from the secondary transfer nip, and
wherein the charge eliminating member is disposed between the conveyance guide and the holding portion.
